(19) United States
(12) Patent Application Publication
(10) Pub. No.: US 2024/0406886 A1
(43) Pub. Date: Dec. 5, 2024

(54) INFORMATION PROCESSING METHOD AND DEVICE

(71) Applicant: Lenovo (Beijing) Limited, Beijing (CN)

(72) Inventors: Huamei CAO, Beijing (CN); Haoyu ZHAO, Beijing (CN)

(21) Appl. No.: 18/677,465

(22) Filed: May 29, 2024

(30) Foreign Application Priority Data
May 31, 2023 (CN) 202310639585.0

(51) Int. Cl. H04W 52/36; H04W 52/02; H04W 76/30

(52) U.S. Cl. CPC H04W 52/365; H04W 52/0235; H04W 76/30

(57) ABSTRACT

An information processing method includes receiving power headroom report (PHR) information of a user terminal, and in response to determining that the PH information satisfies a target condition, sending a state switch message used to switch an operation state of the user terminal to the user terminal. The PHR information carries power headroom (PH) information of the user terminal. The state switch message is used to instruct the user terminal to switch from a first power consumption operation state to a second power consumption operation state. Power consumption of the first power consumption operation state is greater than power consumption of the second power consumption operation state.

### CROSS-REFERENCE TO RELATED APPLICATION

The present disclosure claims priority to Chinese Patent Application No. 202310639585.0, filed on May 31, 2023, the entire content of which is incorporated herein by reference.

### TECHNICAL FIELD

The present disclosure is related to the information processing technology field and, more particularly, to an information processing method and an information processing device.

### BACKGROUND

When 5G needs to be applied to the Internet of Things, a large number of terminals powered by batteries need to be connected. The battery life of the terminals needs to range from 5 to 10 years, otherwise, the maintenance cost is too high. Thus, the terminal needs to enter an inactive state when no activity exists to extend the battery life. When data needs to be transmitted, the data needs to be transmitted with quick access to the network with a few signals. Currently, only an inactive timer duration at a cell level can be obtained from an Extensive Markup Language (XML) configuration file, and user equipment (UE) is adjusted to the inactive state based on the inactive timer duration. However, conditions for all users in the same cell to enter the inactive state are the same. The inactive timer duration is determined by a parameter in the XML file. Thus, the time duration of the inactive state cannot be customized for the users and is not generally adaptive.

### SUMMARY

An aspect of the present disclosure provides an information processing method. The method includes receiving power headroom report (PHR) information of a user terminal sent by the user terminal, and in response to determining that the PH information satisfies a target condition, sending a state switch message used to switch an operation state of the user terminal to the user terminal. The PHR information carries power headroom (PH) information of the user terminal. The state switch message is used to instruct the user terminal to switch from a first power consumption operation state to a second power consumption operation state. Power consumption of the first power consumption operation state is greater than power consumption of the second power consumption operation state.

An aspect of the present disclosure provides an information processing method. The method includes obtaining power headroom (PH) information of a user terminal, sending power headroom report (PHR) information carrying the PH information to a base station, receiving a state switch message sent by the base station used to switch an operation state of the user terminal, and switching the operation state of the user terminal from a first power consumption operation state to a second power consumption operation state based on the state switch message. Power consumption of the first power consumption operation state is greater than power consumption of the second power consumption operation state.

An aspect of the present disclosure provides a base station, including one or more first processors, one or more first memories, and one or more first communication buses. The one or more first memories store an information processing program that, when executed by the one or more first memories, causes the one or more first processors to receive power headroom report (PHR) information of a user terminal sent by the user terminal, and in response to determining that the PH information satisfies a target condition, send a state switch message used to switch an operation state of the user terminal to the user terminal. The PHR information carries power headroom (PH) information of the user terminal. The state switch message is used to instruct the user terminal to switch from a first power consumption operation state to a second power consumption operation state. Power consumption of the first power consumption operation state is greater than power consumption of the second power consumption operation state. The one or more first communication buses are used to realize the communicative connection between the one or more processors and the one or more memories.

### BRIEF DESCRIPTION OF THE DRAWINGS

FIG. 1 illustrates a schematic flowchart of an information processing method according to some embodiments of the present disclosure.

FIG. 2 illustrates a schematic flowchart of another information processing method according to some embodiments of the present disclosure.

FIG. 3 illustrates a schematic flowchart of another information processing method according to some embodiments of the present disclosure.

FIG. 4 illustrates a schematic diagram showing communication between a base station and a user equipment (UE) of an information processing method according to some embodiments of the present disclosure.

FIG. 5 illustrates a schematic flowchart of another information processing method according to some embodiments of the present disclosure.

FIG. 6 illustrates a schematic flowchart of another information processing method according to some embodiments of the present disclosure.

FIG. 7 illustrates a schematic flowchart of another information processing method according to some embodiments of the present disclosure.

FIG. 8 illustrates a schematic structural diagram of a first information processing apparatus according to some embodiments of the present disclosure.

FIG. 9 illustrates a schematic structural diagram of a second information processing apparatus according to some embodiments of the present disclosure.

FIG. 10 illustrates a schematic structural diagram of a base station according to some embodiments of the present disclosure.

FIG. 11 illustrates a schematic structural diagram of a user terminal according to some embodiments of the present disclosure

### DETAILED DESCRIPTION OF THE EMBODIMENTS

In connection with the accompanying drawings of embodiments of the present disclosure, the technical solutions of embodiments of the present disclosure are described in detail.

Embodiments of the present disclosure provide an information processing method. The method is applied to a base station. As shown in FIG. 1, the method includes the following steps.

At 101, power headroom report (PHR) information sent by a user terminal is received.

The PHR information can carry power headroom information of the user terminal.

In some embodiments, the user terminal can refer to a User Equipment (UE). The PHR information of the user terminal can refer to the PHR of the UE. The PHR can be a process of the UE reporting power headroom to a network side. A value of the power headroom can be sent by a control unit of a medium access control (MAC) layer. Thus, the MAC control unit related to the transmission of the power headroom can be referred to as a PHR control unit. The PHR control unit can fixedly occupy one byte. High 2 bits are “R” bit, i.e., reserved bits, which are temporarily unused. As shown in Table 1, only low 6 bits are used to store 64 PH level values ranging from 0 to 63. Table 1 shows a correspondence between each PH value and a power headroom level corresponding to the PH value. Each PH level can correspond to an actual dB value. For example, when the UE needs to report a PH value of −22 dB, only a value of 1 needs to be filled in the PHR control unit of the MAC.

TABLE 1

| PH | Power Headroom Level |
|---|---|
| 0 | POWER_HEADROOM_0 |
| 1 | POWER_HEADROOM_1 |
| 2 | POWER_HEADROOM_2 |
| 3 | POWER_HEADROOM_3 |
| . . . | . . . |
| 60 | POWER_HEADROOM_60 |
| 61 | POWER_HEADROOM_61 |
| 62 | POWER_HEADROOM_62 |
| 63 | POWER_HEADROOM_63 |

The power headroom (PH) information can refer to a difference between a maximum allowed transmission power of the UE and the currently evaluated transmission power at the Physical Uplink Shared Channel (PUSCH). The PH information can indicate how much transmission power of the UE is available in addition to the transmission power used by the current PUSCH transmission. The unit of the PH can be dB, and the PH can range from −23 dB to +40 dB. A negative value can indicate that the network side schedules a data transmission rate for the UE higher than the data transmission rate that can be supported by the transmission power of the UE (i.e., the obtained PUSCH transmission power being greater than the maximum allowed transmission power of the UE). Since the PH calculation needs to use the transmission power of the PUSCH, the power headroom may only need to be calculated at a transmission subframe of the PUSCH.

At 102, when the PH information is determined to meet a target condition, a state switch message used to switch an operation state of the user terminal is sent to the user terminal.

The state switch message can be used to indicate the user terminal to switch from a first power consumption operation state to a second power consumption operation state. The power consumption of the first power consumption operation state can be greater than the power consumption of the second power consumption operation state.

In embodiments of the present disclosure, whether the PH information satisfies the target condition can be determined by determining whether the value of the PH information (i.e., PH value) satisfies the target value. If the PH value satisfies the target value, the PH information can be determined to satisfy the target condition. If the PH value does not satisfy the target value, the PH information can be determined to not satisfy the target condition. In addition, when the PH value satisfies the target value, the base station can send a state switch message instructing the UE to switch the operation state to the UE. Thus, after the UE receives the state switch message, the UE can switch the operation state from the first power consumption operation state to the second power consumption operation state. In some other embodiments, the power consumption of the first power consumption operation state can also be smaller than the power consumption of the second power consumption operation state.

The UE can switch the operation state of the UE in real time according to the PH value. The UE with the PH value satisfying the target value can be switched with the operation state. The operation states of all pieces of UE are not switched at once. Meanwhile, since the operation state is switched in real-time according to the PH value of the UE, the method can be suitable for any scenario that requires flexible switching of the operation state of the UE, which is different from the existing technology that is only suitable for switching the operation states of all pieces of UE simultaneously.

In the information processing method of embodiments of the present disclosure, the base station can select when to switch the operation state of which user terminal according to the current PH information of the user terminal in the range where the user terminal belongs. The corresponding state switch message can be sent to the user terminal to further cause the user terminal to respond to the state switch message to switch the operation state of the user terminal from the first power consumption operation state to the second power consumption operation state, instead of switching the operation states of all the user terminals to the same state. Thus, the problem of being unable to adjust the customized time duration of the inactive state of the terminal in the existing technology can be solved. The technical solution can be generally adaptive.

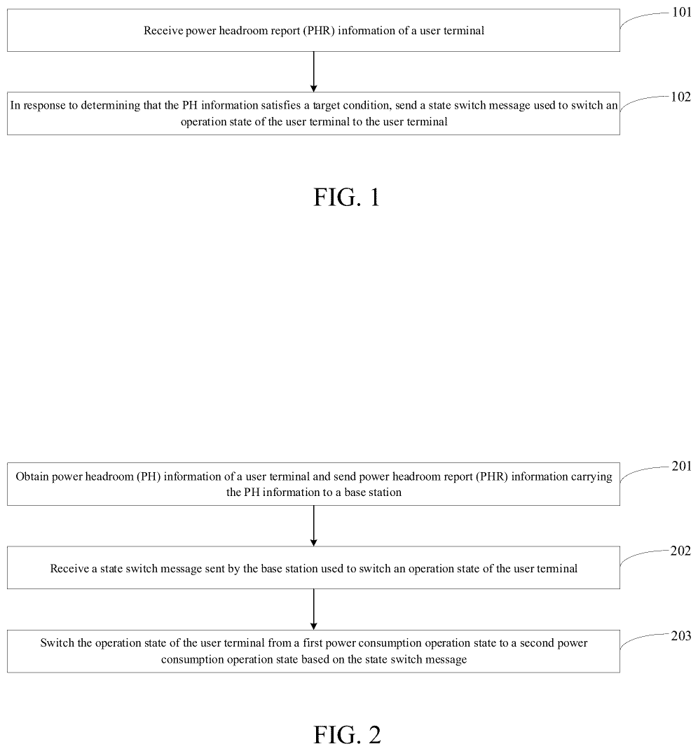

Embodiments of the present disclosure provide an information processing method. The method can be applied to a user terminal. As shown in FIG. 2, the method includes the following steps.

At 201, PH information of the user terminal is obtained, and PHR information carrying the PH information is sent to the base station.

In embodiments of the present disclosure, the PH information of the UE can be determined and can be obtained from the information related to the UE. The PH information cannot be directly sent to the base station but can be sent to the base station through the PHR. The UE can carry the PH information of the UE in the PHR. Then, the PHR information can be sent to the base station. Then, the base station can obtain the PH information of the UE corresponding to the base station.

At 202, the state switch message used to switch the operation state of the user terminal sent by the base station is received.

In embodiments of the present disclosure, after receiving the PHR of the UE corresponding to the base station, the base station can obtain the PH information of each piece of UE from the PHR. Then, after obtaining the PH information of each piece of UE, the base station can perform analysis on the PH information of each piece of UE to determine which piece of UE needs to switch the operation state. That is, the base station can determine whether the operation state of the UE needs to be switched according to whether the PH information satisfies the target condition. If the PH value satisfies the target value, the PH information is indicated to satisfy the target condition. Then, the base station can send the state switch information to the UE, and the UE can receive the state switch information sent by the base station.

If the PH information satisfies the target condition, it indicates that the UE currently needs to enter another operation state with different power consumption than the current operation state.

At 203, based on the state switch message, the operation state of the user terminal is switched from the first power consumption operation state to the second power consumption operation state.

The power consumption of the first power consumption operation state can be greater than the power consumption of the second power consumption operation state.

In some embodiments of the present disclosure, after receiving the state switch message sent by the base station, the UE can respond to the state switch message and switch the operation state of the UE from the first power consumption operation state to the second power consumption operation state. Different pieces of UE in the same cell can self-adaptively adjust according to the PH value to enter the second power consumption operation state with a smaller power efficiency. Thus, an effect of electricity and power saving can be achieved, and the battery life of the UE can be extended.

In some embodiments, the first power consumption operation state can refer to a non-inactive state, and the second power consumption operation state can refer to an inactive state.

For the same steps and contents, reference can be made to the description above, which is not repeated here.

In the information processing method of embodiments of the present disclosure, the base station can send the state switch message to the user terminal that needs to switch the operation state according to the current PH information of the user terminal within the range of the base station. Only the user terminal that receives the state switch message can switch the operation state from the first power consumption operation state to the second power consumption operation state. That is, the user terminal that does not receive the state switch message will not switch the operation state to the second power consumption operation state. Thus, not all the user terminals can switch the operation states to the same state. Thus, the problem of the existing technology of being unable to adjust the customized time duration of the inactive state for the terminal can be solved, and the technical solution can be generally adaptive.

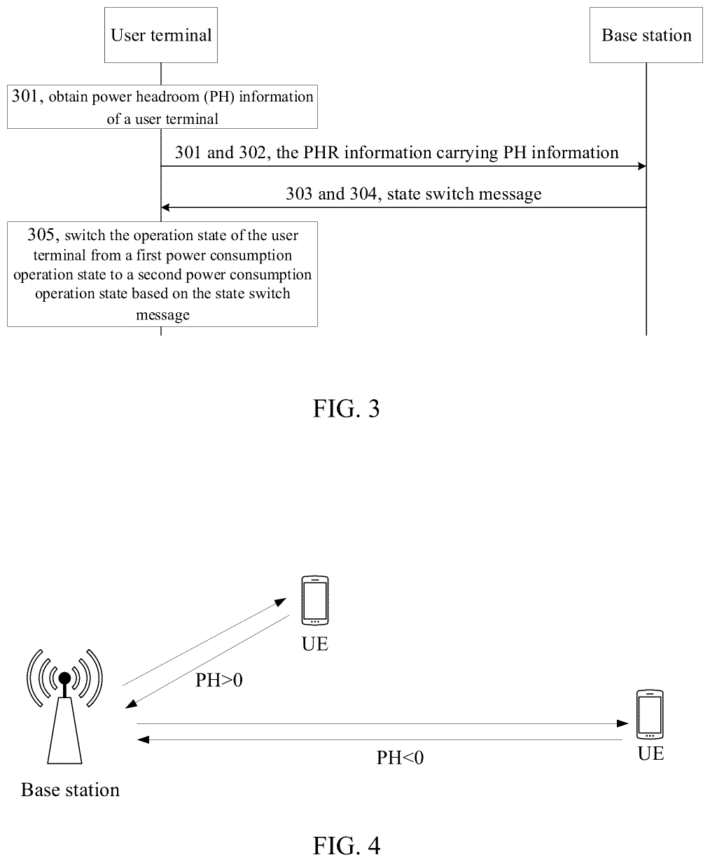

Based on the above, embodiments of the present disclosure provide an information processing method. As shown in FIG. 3, the method includes the following steps.

At 301, the user terminal obtains the PH information of the user terminal and sends the PHR information carrying the PH information to the base station.

At 302, the base station receives the PHR information of the user terminal sent by the user terminal.

The PHR information can carry the PH information of the user terminal.

At 303, when the value of the PH information is determined to be less than the target value, the base station sends the state switch message to the user terminal.

In some embodiments, if the PH value is less than the target value, the current operation state of the UE may need to be switched. That is, when the current operation state of the UE may not match the actual operation condition, the base station may determine that the operation state of the UE needs to be switched. Then, the base station can generate and send the state switch message to the corresponding UE.

The target value can be predetermined according to historical data. In addition, the target value can represent the value when the signal of UE has reached the maximum transmission power. In some embodiments, the target value can be 0.

As shown in FIG. 4, if the PH value is less than 0, the transmission power corresponding to the current transmission signal of the UE has reached the maximum transmission power. That is, the power required for the UE to send the signal is large at this point. That is, the UE is far away from the base station and is no longer suitable to perform the current signal transmission operation, and the power consumption is large. Then, to save the power of the battery of the UE and extend the battery life, when only a part of the UE needs to operate, the operation state of the UE needs to be switched from the non-inactive state to the inactive state to ensure the resources to be used appropriately.

In addition, if the PH value is greater than 0, additional power can be available for the UE with the current transmission power. That is, the transmission power when the UE sends the signal may not reach the maximal value. Thus, the UE may be close to the base station, and the power consumption of the UE is not large. The UE can continue to operate in the current non-inactive state.

Step 303 can be implemented by the following steps.

At 303a, when the value of the PH information is determined to be less than the target value through the distribution unit of the base station, the base station sends the state switch message to the user terminal through the distribution unit of the base station and the centralized unit of the base station.

In embodiments of the present disclosure, the base station can determine the current PH values of the pieces of UE and the target values through the distribution unit (DU) of the base station. That is, the DU can determine a relationship between the current PH value of each UE reported by the UE of the pieces of UE belonging to the base station and 0. Moreover, when the DU determines that the current PH value of the UE is smaller than 0, the DU can notify the UE that the transmission power currently used by the UE to send the signal achieves the maximal transmission power. Then, the DU and the centralized unit (CU) can cooperate with each other to notify the UE to switch the operation state of the UE. That is, when the DU determines that the current PH value of the UE reported by the UE is smaller than 0, the DU and the CU can cooperate with each other to send the state switch message to the UE.

At 304, the user terminal receives the state switch message sent by the base station used to switch the operation state of the user terminal.

At 305, based on the state switch message, the operation state of the user terminal is switched from the first power consumption operation state to the second power consumption operation state.

The power consumption of the first power consumption operation state can be greater than the power consumption of the second power consumption operation state.

In embodiments of the present disclosure, based on the different PH values of different pieces of the UE, the operation state of the UE with the PH value less than zero can be switched to the inactive state. Thus, the UE that is far away from the base station can self-adaptively enter the inactive state more easily to save power.

For the same steps and contents, reference can be made to the descriptions above, which are not repeated here.

In the information processing method of embodiments of the present disclosure, the base station can select when to switch the operation state of which user terminal according to the current PH information of the user terminal within the range of the base station. The base station can send the corresponding state switch information to the user terminal that needs to switch the operation state of the user terminal. Then, the user terminal can respond to the state switch message to switch the operation state of the user terminal from the first power consumption operation state to the second power consumption operation state. The operation states of all the user terminals may not be switched to the same state simultaneously. Thus, the problem of the existing technology of being unable to adjust the customized time duration of the inactive state of the terminal can be solved, and the technical solution can be generally adaptive.

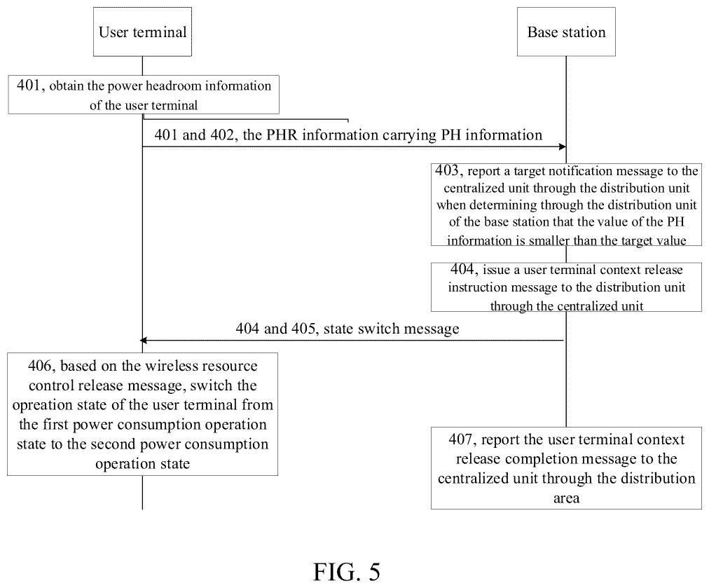

Based on the above, embodiments of the present disclosure provide an information processing method. As shown in FIG. 5, the method includes the following steps.

At 401, the user terminal obtains the PH information of the user terminal and sends PHR information carrying the PH information to the base station.

At 402, the base station receives the PHR information of the user terminal sent by the user terminal.

The PHR information can carry the PH information of the user terminal.

At 402, when the PH information is determined to be smaller than the target value by the distribution unit of the base station, the base station reports a target notification message to the centralized unit through the distribution unit.

The target notification message can be used to notify the centralized unit that the user terminal needs to be switched to the second power consumption operation state.

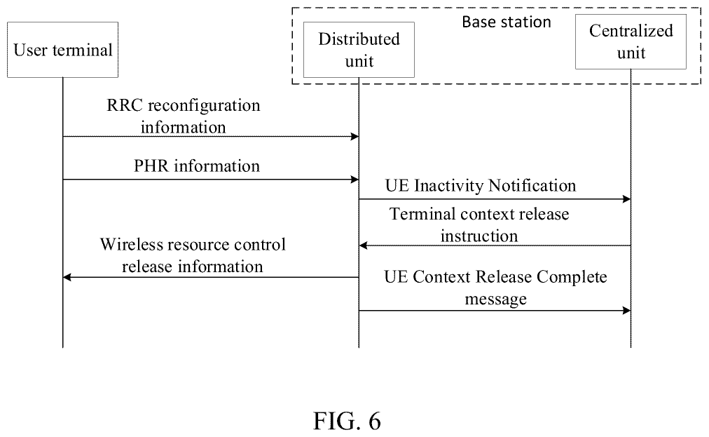

In embodiments of the present disclosure, the target notification message can refer to a UE Inactivity Notification message. That is, if the DU determines that the PH of the UE is smaller than 0, as shown in FIG. 6, the DU reports the UE Inactivity Notification to the CU to notify the CU that the UE needs to be switched to the inactive state. Each base station can include one CU. One CU can be configured to control a plurality of DUs, and each DU can be configured to support one or more cells.

When the UE is accessed, as shown in FIG. 6, the base station carries the PHR configuration (Phr-Config) in a Radio Resource Control (RRC) reconfiguration information. Phr-Config includes a report cycle and a transmission power change factor. In some embodiments, the currently set report cycle timer (phr-PeriodicTimer) can be 200 ms, and a transmission end power change factor (phr-Tx-PowerFactorChange) can be dB1. In addition, the UE can report the PHR due to a path loss change reference. Currently, the PHR can be brought up by the MAC control element (CE) at the Uplink Shared Channe (ULSCH).

At 404, the base station sends a user terminal context release instruction message to the distribution unit through the centralized unit and sends a wireless resource control release message to the user terminal through the distribution unit.

The state switch message can include the wireless resource control release message.

In embodiments of the present disclosure, after receiving the UE Inactivity Notification message sent by the distribution unit, the central unit sends a UE Context Release Instruction message to the distribution unit, and then the distribution unit sends a wireless resource control release (RRC Release) message to the UE to transition the UE to the Inactive state.

At 405, the user terminal receives the wireless resource control release message sent by the base station.

At 406, based on the wireless resource control release message, the user terminal switches the operation state of the user terminal from the first power consumption operation state to the second power consumption operation state.

The power consumption of the first power consumption operation state can be greater than the power consumption of the second operation state.

In embodiments of the present disclosure, the UE can receive the RRC Release message sent by the distribution unit of the base station. Moreover, after the UE receives the RRC Release message, the UE can switch the operation state of the UE from the non-inactive state to the inactive state.

At 407, the base station reports a user terminal context release completion message to the centralized unit through the distribution unit.

After the DU sends the RRC Release message to the UE, the DU can send the UE Context Release Completion message to the CU to inform the CU that the UE has received the RRC Release message.

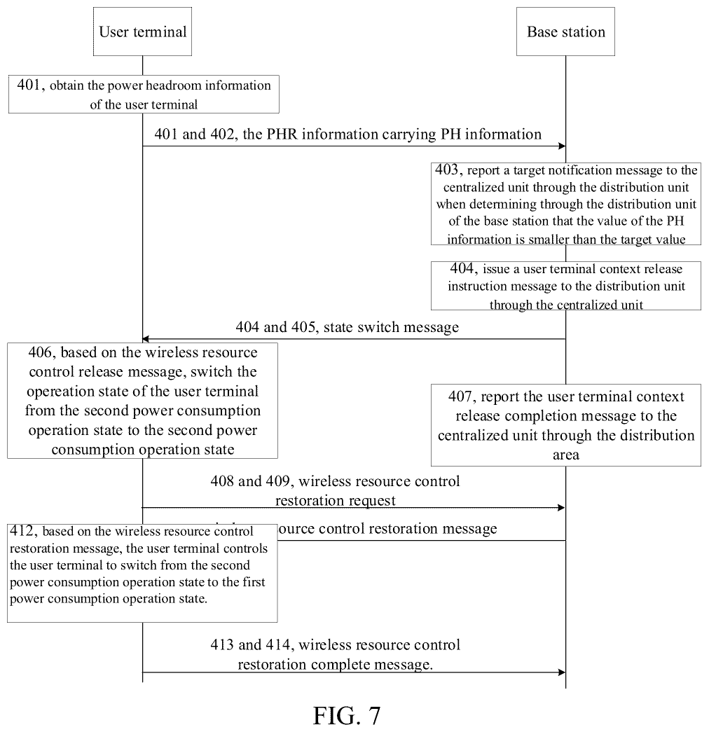

In other embodiments of the present disclosure, as shown in FIG. 7, the method further includes the following steps.

At 408, the user terminal sends a wireless resource control restoration request to the base station.

The wireless resource control restoration request can be transmitted when the PH of the UE has recovered to PH>0, i.e., the transmission power required for the UE to currently transmit the signal does not reach the maximal value of the transmission power. That is, the UE can transmit the signal normally at this time and may need to be switched back to the non-inactive state.

At 409, the base station receives the wireless resource control restoration request sent by the user terminal.

At 410, the base station sends the wireless resource control restoration message to the user terminal in response to the wireless resource control restoration request.

In embodiments of the present disclosure, the DU of the base station can receive the wireless resource control restoration request sent by the UE. Then, the DU can upload the wireless resource control restoration request to the CU of the base station. Then, the CU can issue a wireless resource control restoration message for the wireless resource control restoration request to the DU. Thus, the DU can issue the wireless resource control restoration message to the UE to facilitate the UE to switch the operation state of the UE from the inactive state to the non-inactive state.

At 411, the user terminal receives the wireless resource control restoration message sent by the base station for the wireless resource control restoration request.

At 412, based on the wireless resource control restoration message, the user terminal controls the user terminal to switch from the second power consumption operation state to the first power consumption operation state.

In embodiments of the present disclosure, the UE can receive the wireless resource control restoration message sent by the DU of the base station. Then, the UE can respond to the wireless resource control restoration message to switch the operation state of the UE from the inactive state to the non-inactive state to cause the UE to transmit the signal normally. That is, the UE can be restored to the normal signal reception and transmission state.

At 413, when determining that the user terminal is switched to the first power consumption operation state, the user terminal sends a wireless resource control restoration completion message to the base station.

At 414, the base station receives the wireless resource control restoration completion message sent by the user terminal.

In embodiments of the present disclosure, after determining that the operation state of the UE is switched back to the non-inactive state, the UE can send the wireless resource control restoration completion message to the DU of the base station. The DU can then forward the wireless resource control restoration completion message to the CU of the base station. Thus, the base station can know that the operation state of the UE is switched back to the non-inactive state. Then, the base station can provide a normal signal reception and transmission function to the UE.

For the same steps and contents, reference can be made to the description above, which is not repeated here.

In the information processing method of embodiments of the present disclosure, the base station can select when to switch the operation state of which user terminal based on the current PH information of the user terminal within the range of the base station and send the corresponding state switch information to the user terminal that needs to switch the operation state. Thus, the user terminal can respond to the state switch message to switch the operation state of the user terminal from the first power consumption operation state and the second power consumption operation state instead of switching the operation states of all the user terminals to the same state. Thus, the problem of the existing technology being unable to adjust the customized time direction of the inactive state of the user terminal, and the technical solution can be generally adaptive.

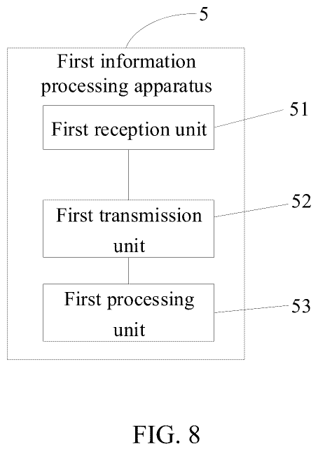

Based on the above, embodiments of the present disclosure provide a first information processing apparatus. The first information processing apparatus can be applied to the information processing methods shown in FIG. 1, FIG. 3, FIG. 5, and FIG. 7. As shown in FIG. 8, the first information processing apparatus 5 includes a first reception unit 51 and a first transmission unit 52.

The first reception unit 51 can be configured to receive the PHR information of the user terminal sent by the user terminal.

The PHR information can carry the PH information of the user terminal.

The first transmission unit 52 can be configured to, when determining that the PH information satisfies the target condition, send the state switch message used to switch the operation state of the user terminal to the user terminal.

The state switch message can be used to instruct the user terminal to switch from the first power consumption operation state to the second power consumption operation state. The power consumption of the first power consumption operation state can be greater than the power consumption of the second power consumption operation state.

In some other embodiments of the present disclosure, the first transmission unit 52 can be further configured to, when determining that the value of the PH information is smaller than the target value, send the state switch message to the user terminal.

In some other embodiments of the present disclosure, the first transmission unit 52 can be further configured to, when determining that the value of the PH information is smaller than the target value through the distribution unit of the base station, send the state switch message to the user terminal through the distribution unit and the centralized unit of the base station.

send state transition messages to user terminals when the value of the power headroom information is less than the target value.

In some other embodiments of the present disclosure, the first transmission unit 52 can be further configured to report the target notification message to the centralized unit through the distribution unit, the target notification message being used to inform the centralized unit that the user terminal needs to be switched to the second power consumption operation state, and issue the user terminal context release instruction message to the distribution unit through the centralized unit. The state switch message can include a wireless resource control release message.

In some other embodiments of the present disclosure, the first information processing apparatus 5 can further include a first processing unit 53 configured to report the user terminal context release completion message through the distribution unit.

In some other embodiments of the present disclosure, the first reception unit 51 can be configured to receive the wireless resource control restoration request sent by the user terminal.

The first transmission unit 52 can be further configured to send the wireless resource control restoration message to the user terminal for the wireless resource control restoration request. The wireless resource control restoration message can be used to instruct the user terminal to switch from the second power consumption operation state to the first power consumption operation state.

The first reception unit can be further configured to receive the wireless resource control restoration completion message sent by the user terminal. The wireless resource control restoration completion message can be sent after the user terminal is switched to the first power consumption operation state.

For the steps of the units, reference can be made to the information processing methods as shown in FIG. 1, FIG. 3, FIG. 5, and FIG. 7, which are not repeated here.

In the first information processing apparatus of embodiments of the present disclosure, the base station can select when to switch the operation state of which user terminal according to the current PH information of the user terminal within the range of the base station and send the corresponding state switch information to the user terminal. Thus, the user terminal can respond to the state switch message to switch the operation state of the user terminal from the first power consumption operation state to the second power consumption operation state instead of switching the operation states of all the user terminals to the same state together. Thus, the problem of the existing technology being unable to adjust the customized time duration of the inactive state, and the technical solution can be generally adaptive.

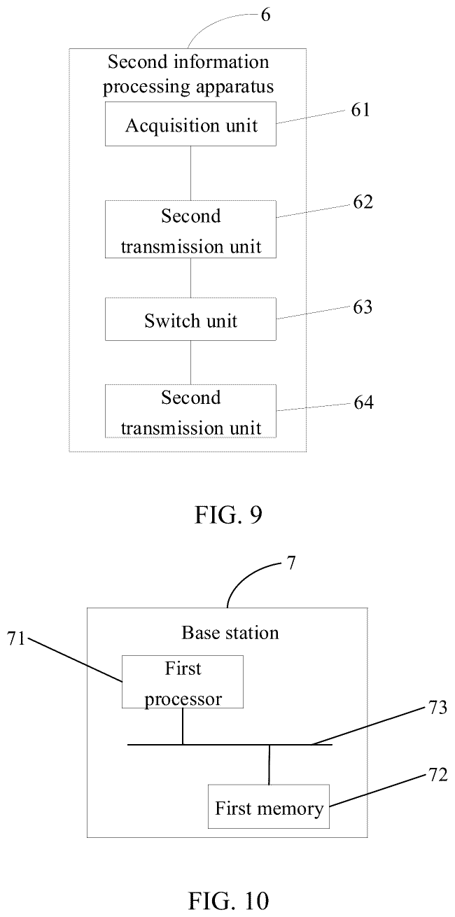

Based on the above, embodiments of the present disclosure provide a second information processing apparatus. The second information processing apparatus can be applied to the information processing methods above corresponding to FIG. 2, FIG. 3, FIG. 5, and FIG. 7. As shown in FIG. 9, the second information processing apparatus 6 can include an acquisition unit 61, a second reception unit 62, and a switch unit 63.

The acquisition unit 61 can be used to obtain the PH information of the user terminal and send the PHR information carrying the PH information to the base station,

The second reception unit 62 can be configured to receive the state switch message used to switch the operation state of the user terminal sent by the base station.

The switch unit 63 can be configured to switch the operation state of the user terminal from the first power consumption operation state to the second power consumption operation state based on the state switch message. The power consumption of the first power consumption operation state can be greater than the second power consumption operation state.

In some other embodiments of the present disclosure, the second information processing apparatus 6 can include a second transmission unit 64, a second reception unit 62, and a switch unit 63.

The second transmission unit 64 can be configured to transmit the wireless resource control restoration request to the base station.

The second reception unit 62 can be configured to the wireless resource control restoration message sent by the base station for the wireless resource control restoration request.

The switch unit 63 can be configured to, based on the wireless resource control restoration message, control the user terminal to be switched from the second power consumption operation state to the first power consumption operation state.

The second transmission unit 64 can be further configured to when determining that the user terminal is switched to the first power consumption operation state, send the wireless resource control restoration completion message to the base station.

For the description of the steps of the units, reference can be made to the information processing methods corresponding to FIG. 2, FIG. 3, FIG. 5, and FIG. 7, which are not repeated.

In the second information processing apparatus of embodiments of the present disclosure, the base station can send the state switch message to the user terminal that needs to switch the operation state according to the current PH information of the user terminal within the range of the base station. Thus, only the user terminal that receives the state switch message can switch the operation state of the user terminal from the first power consumption operation state to the second power consumption operation state. That is, the user terminal that does not receive the state switch message cannot switch the operation state of the user terminal to the second power consumption operation state instead of switching the operation states of all the user terminals to the same state together. Thus, the problem of the existing technology being unable to adjust the customized time duration of the inactive state, and the technical solution can be generally adaptive.

Based on the above, embodiments of the present disclosure provide a base station. The base station is applied to the information processing methods as shown in FIG. 1, FIG. 3, FIG. 5, and FIG. 7. As shown in FIG. 10, the base station 7 includes a first processor 71, a first storage device, and a first communication bus 73.

The first communication bus 73 can be configured to realize a communicative connection between the first processor 71 and the first storage device 72.

The first processor 71 can be configured to execute an information processing program in the first storage device 72 to receive the PHR information of the user terminal sent by the user terminal, the PHR information carrying the PH information of the user terminal, when determining that the PH information satisfies the target condition, and sending a state switch message used to switch the operation state of the user terminal to the user terminal. The state switch message can be used to instruct the user terminal to be switched from the first power consumption operation state to the second power consumption operation state. The power consumption of the first power consumption operation state can be greater than the power consumption of the second power consumption operation state.

In some other embodiments of the present disclosure, the first processor 71 can be configured to execute the information processing program in the first storage device 72 to send the state switch message used to switch the operation state of the user terminal to the user terminal when determining that the PH information satisfies the target condition to send the state switch message to the user terminal when determining that the value of the PH information is smaller than the target value.

In some other embodiments of the present disclosure, the first processor 71 can be configured to execute the information processing method in the first storage device 72 to send the state switch message to the user terminal when determining that the value of the PH information is smaller than the target value to send the state switch message to the user terminal through the distribution unit and the centralized unit of the base station when determining through the distribution unit of the base station that the value of the PH information is smaller than the target value.

In some other embodiments of the present disclosure, the first processor 71 can be configured to execute the information processing program in the first storage device 72 to send the state switch message to the user terminal through the distribution unit and the centralized unit of the base station to report the target notification message to the centralized unit through the distribution unit, the target notification message being used to inform the centralized unit that the user terminal is switched to the second power consumption operation state, and issue the user terminal context release instruction message to the distribution unit through the centralized unit and send the wireless resource control release message to the user terminal through the distribution unit. The state switch message can include the wireless resource control release message.

In some other embodiments of the present disclosure, the first processor 71 can be configured to execute the information processing program to report the user terminal context release completion message to the centralized unit through the distribution unit.

In some other embodiments of the present disclosure, the first processor 71 can be configured to execute the information processing program in the first storage device 72 to receive the wireless resource control restoration request sent by the user terminal, send the wireless resource control restoration message for the wireless resource control restoration request to the user terminal, and receive the wireless resource control restoration completion message sent by the user terminal. The wireless resource control restoration message can be used to instruct the user terminal to switch from the second power consumption operation state to the first power consumption operation state. The wireless resource control restoration completion message can be sent after the user terminal is switched to the first power consumption operation state.

For the implementation process of the steps executed by the first processor, reference can be made to the implementation processes of the information processing methods corresponding to FIG. 1, FIG. 3, FIG. 5, and FIG. 7, which are not repeated here.

The base station of embodiments of the present disclosure can select when to switch the operation state of which user terminal according to the current PH information of the user terminal within the range of the base station and send the corresponding state switch information to the user terminal. Thus, the user terminal can switch the operation state of the user terminal from the first power consumption operation state to the second power consumption operation state in response to the state switch message instead of switching the operation states of all the user terminals to the same state together. The problem of the existing technology being unable to adjust the customized time duration of the inactive state can be solved, and the technical solution can be generally adaptive.

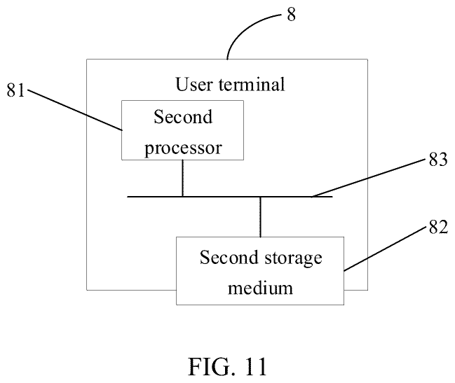

Based on the above, embodiments of the present disclosure provide a user terminal. The user terminal is applied to the information processing methods corresponding to FIG. 2, FIG. 3, FIG. 5, and FIG. 7. As shown in FIG. 11, the user terminal 8 includes a second processor 81, a second storage device 82, and a second communication bus 83.

The second communication bus 83 can be configured to realize the communicative connection between the second processor 81 and the second storage device 82.

The second processor 81 can be configured to execute the information processing program in the second storage device 82 to obtain the PH information of the user terminal, send the PHR information carrying the PH information to the base station, receive the state switch message used to switch the operation state of the user terminal sent by the base station, and based on the state switch message, switch the operation state of the user terminal from the first power consumption operation state to the second power consumption operation state. The power consumption of the first power consumption operation state can be greater than the power consumption of the second power consumption operation state.

In some other embodiments, the second processor 81 can be configured to execute the information processing program in the second storage device 82 to send the wireless resource control restoration request to the base station, receive the wireless resource control restoration message sent by the base station for the wireless resource control restoration request, based on the wireless resource control restoration message, control the user to switch from the second power consumption operation state to the first power consumption operation state, and when determining that the user terminal is switched to the first power consumption operation state, send the wireless resource control restoration completion message to the base station.

For the implementation process of steps executed by the second processor, reference can be made to the implementation processes of the information processing methods corresponding to FIG. 2, FIG. 3, FIG. 5, and FIG. 7, which are not repeated here.

After receiving the state switch message sent by the base station, the user terminal of embodiments of the present disclosure can switch the operation state of the user terminal from the first power consumption operation state to the second power consumption operation state. The user terminal that does not receive the state switch message sent by the base station cannot switch the operation state of the user terminal to the second power consumption operation state. The state switch message can be determined by the base station according to the current PH information of the user terminal within the range of the base station. The operation states of all the user terminals are not switched to the same state together. Thus, the problem of the existing technology being unable to adjust the customized time duration of the inactive state can be solved, and the technical solution can be generally adaptive.

Based on the above, embodiments of the present disclosure provide a computer-readable storage medium. The computer-readable storage medium can store one or more programs that, when executed by one or more processors, cause the one or more processors to implement the information processing methods corresponding to FIGS. 1 to 3, FIG. 5, and FIG. 7.

Those skilled in the art should understand that embodiments of the present disclosure can be provided as methods, systems, or computer program products. Thus, the present disclosure can be implemented by hardware embodiments, software embodiments, or a combination of software and hardware embodiments. The present disclosure can be implemented as the computer program products at one or more computer-readable storage media (including but not limited to a magnetic storage device and an optical storage device) including computer-executable program codes.

The present disclosure is described according to the flowchart and/or block diagram of the methods, devices (systems), and computer program products of embodiments of the present disclosure. Each process and/or block of the flowchart and/or block diagram and the combination of the processes and/or blocks of the flowchart and/or block diagram can be implemented by the computer program instructions. The computer program instructions can be provided to a general-purpose computer, special-purpose computer, embedded processor, or processor of another programmable data processing device to generate a machine. Thus, the instructions executed by the processor of the computer or another programmable data processing device can generate an apparatus configured to implement the functions determined in one or more processes of the flowchart and/or one or more blocks of the block diagram.

The computer program instructions can also be stored in the computer-readable storage device that boots the computer or the another programmable data processing device to operate in a specific method. Thus, the instructions stored in the computer-readable storage device can generate a product including an instruction apparatus. The instruction apparatus can be configured to implement the functions determined in one or more processes of the flowchart and/or one or more blocks of the block diagram.

The computer program instruction can also be loaded to the computer or the another programmable data processing device. Thus, a series of operational steps can be executed at the computer or the another programmable data processing device to generate the processing implemented by the computer. Thus, the instructions can be executed at the computer or the another programmable device to provide steps of implementing the functions determined in one or more processes of the flowchart and/or one or more blocks of the block diagram.

The above are some embodiments of the present disclosure and are not used to limit the scope of the present disclosure.

What is claimed is:

1. An information processing method comprising:
receiving power headroom report (PHR) information of a user terminal, the PHR information carrying power headroom (PH) information of the user terminal; and
in response to determining that the PH information satisfies a target condition, sending a state switch message used to switch an operation state of the user terminal to the user terminal, the state switch message being used to instruct the user terminal to switch from a first power consumption operation state to a second power consumption operation state, and power consumption of the first power consumption operation state being greater than power consumption of the second power consumption operation state.

2. The method according to claim 1, wherein sending the state transition message used to switch the operation state of the user terminal to the user terminal in response to determining that the PH information of the user terminal satisfies the target condition includes:
sending the state switch message to the user terminal in response to determining that a value of the PH information is less than a target value.

3. The method according to claim 2, wherein sending the state transition message to the user terminal when determining that the value of the PH information is less than the target value includes:
sending the state switch message to the user terminal through a distribution unit and a centralized unit of the base station in response to determining through the distribution unit of the base station that the value of the PH information is less than the target value.

4. The method according to claim 3, wherein sending the state switch message to the user terminal through the distribution unit and the centralized unit of the base station includes:
reporting a target notification message to the centralized unit through the distribution unit, the target notification message being used to inform the centralized unit that the user terminal needs to be switched to the second power consumption operation state; and
issuing a user terminal context release instruction message to the distribution unit through the centralized unit, and sending a wireless resource control release message to the user terminal through the distribution unit, the state switch message including the wireless resource control release message.

5. The method according to claim 4, further comprising:
reporting a user terminal context release completion message to the centralized unit through the distribution unit.

6. The method according to claim 1, further comprising:
receiving a wireless resource control restoration request sent by the user terminal;
sending a wireless resource control restoration message for the wireless resource control restoration request to the user terminal, the wireless resource control restoration message being used to instruct the user terminal to switch from the second power consumption operation state to the first power consumption operation state; and
receiving a wireless resource control restoration completion message sent by the user terminal, the wireless resource control restoration completion message being sent after the user terminal is switched to the first power consumption operation state.

7. An information processing method comprising:
obtaining power headroom (PH) information of a user terminal and sending power headroom report (PHR) information carrying the PH information to a base station;
receiving a state switch message sent by the base station used to switch an operation state of the user terminal; and
switching the operation state of the user terminal from a first power consumption operation state to a second power consumption operation state based on the state switch message, power consumption of the first power consumption operation state being greater than power consumption of the second power consumption operation state.

8. The method according to claim 7, further comprising:
sending a wireless resource control restoration request to the base station;
receiving a wireless resource control restoration message sent by the base station for the wireless resource control restoration request;
controlling the user terminal to switch from the second power consumption operation state to the first power consumption operation state based on the wireless resource control restoration message; and
sending a wireless resource control restoration completion message to the base station in response to determining that the user terminal is switched to the first power consumption operation state.

9. A base station comprising:
one or more first processors;
one or more first memories storing an information processing program that, when executed by the one or more first memories, causes the one or more first processors to:
receive power headroom report (PHR) information of a user terminal sent, the PHR information carrying power headroom (PH) information of the user terminal; and
in response to determining that the PH information satisfies a target condition, send a state switch message used to switch an operation state of the user terminal to the user terminal, the state switch message being used to instruct the user terminal to switch from a first power consumption operation state to a second power consumption operation state, and power consumption of the first power consumption operation state being greater than power consumption of the second power consumption operation state; and
one or more first buses used to realize a communicative connection between the one or more first processors and the one or more first memories.

10. The base station according to claim 9, wherein the one or more processors are further configured to:
send the state switch message to the user terminal in response to determining that a value of the PH information is less than a target value.

11. The base station according to claim 10, wherein the one or more processors are further configured to:
send the state switch message to the user terminal through a distribution unit and a centralized unit of the base station in response to determining through the distribution unit of the base station that the value of the PH information is less than the target value.

12. The base station according to claim 11, wherein the one or more processors are further configured to:
report a target notification message to the centralized unit through the distribution unit, the target notification message being used to inform the centralized unit that the user terminal needs to be switched to the second power consumption operation state; and
issue a user terminal context release instruction message to the distribution unit through the centralized unit, and send a wireless resource control release message to the user terminal through the distribution unit, the state switch message including the wireless resource control release message.

13. The base station according to claim 12, wherein the one or more processors are further configured to:
report a user terminal context release completion message to the centralized unit through the distribution unit.

14. The base station according to claim 9, wherein the one or more processors are further configured to:
receive a wireless resource control restoration request sent by the user terminal;
send a wireless resource control restoration message for the wireless resource control restoration request to the user terminal, the wireless resource control restoration message being used to instruct the user terminal to switch from the second power consumption operation state to the first power consumption operation state; and
receive a wireless resource control restoration completion message sent by the user terminal, the wireless resource control restoration completion message being sent after the user terminal is switched to the first power consumption operation state.
